(19) United States
(12) Patent Application Publication
(10) Pub. No.: US 2009/0108995 A1
(43) Pub. Date: Apr. 30, 2009

(54) Equipment Mounting Systems and Methods for Identifying Equipment

(75) Inventors: Peter T. Tucker, Dallas, TX (US); Daniel W. Macauley, Fishers, IN (US)

Correspondence Address: MYERS BIGEL SIBLEY & SAJOVEC, P.O. BOX 37428, RALEIGH, NC, 27612, US

(73) Assignee: CommScope, Inc.

(21) Appl. No.: 11/928,282

(22) Filed: Oct. 30, 2007

(51) Int. Cl. G06K 7/00; G08B 13/14; H04Q 5/18

(52) U.S. Cl. 340/10.1; 340/572.7

(57) ABSTRACT

An equipment mounting system for rack-mounted devices, such as patch panels, servers, etc., includes a frame that is configured to support equipment mounted thereto in a plurality of spaced-apart mounting locations. A plurality of RF antennas are secured to the frame in spaced-apart relationship such that each antenna is located at a respective mounting location. Each RF antenna is configured to activate and read information from an RFID tag attached to equipment mounted to the frame at a respective mounting location. A microprocessor is configured to selectively activate each antenna to identify the presence of an RFID tag in close proximity to the RF antenna and to read information from an RFID tag. The microprocessor is configured to receive RFID tag information such as equipment identification information and location information, from each antenna and transmit received RFID tag information to a remote device.

### FIELD OF THE INVENTION

The present invention relates generally to communications systems and, more particularly, to communications patching systems.

### BACKGROUND

Many businesses have dedicated communication systems that enable computers, telephones, facsimile machines and the like to communicate with each other through a private network, and with remote locations via a communications service provider. In most buildings, the dedicated communications system is hard wired using communication cables that contain conductive wire. In such hard wired systems, dedicated wires are coupled to individual service ports throughout the building. The wires from the dedicated service ports extend through the walls of the building to a communications closet or closets. The communications lines from the interface hub of a main frame computer and the communication lines from external communication service providers may also terminate within a communications closet.

A patching system is typically used to interconnect the various communication lines within a communications closet. In a communications patching system, all of the communication lines are terminated within a communications closet in an organized manner. The organized terminations of the various lines are provided via the structure of the communications closet. A mounting frame having one or more racks is typically located in a communications closet. The communications lines terminate on the racks, as is explained below.

Referring to FIG. 1, a typical prior art rack 10 is shown. The rack 10 retains a plurality of patch panels 12 that are mounted to the rack 10. On each of the patch panels 12 are located port assemblies 14. The illustrated port assemblies 14 each contain six communication connector ports 16 (e.g., RJ-45 ports, RJ-11 ports, etc.). Other types of patch panels are known, including patch panels with optical fiber ports (e.g., SC, ST and LC ports) and 110 copper wire ports.

Each of the different communication connector ports 16 is hard wired to one of the communication lines. Accordingly, each communication line is terminated on a patch panel 12 in an organized manner. In small patch systems, all communication lines may terminate on the patch panels of the same rack. In larger patch systems, multiple racks may be used, wherein different communication lines terminate on different racks.

In FIG. 1, interconnections between the various communication lines are made using patch cords 20. Both ends of each patch cord 20 are terminated with connectors 22, such as an RJ-45 or RJ-11 communication connector. One end of a patch cord 20 is connected to a connector port 16 of a first communication line and the opposite end of the patch cord 20 is connected to a connector port 16 of a second communications line. By selectively connecting the various lines with patch cords 20, any combination of communication lines can be interconnected.

In large enterprises, the number of patch panels utilized in a communications system can be quite large. In addition, many enterprises are currently investing in large internet data centers. Servers and other equipment for these centers are often arranged in racks in communication closets. As such, enterprises are continuously looking for ways to help them manage communications equipment more efficiently, particularly rack-mounted equipment.

### SUMMARY

In view of the above discussion, systems and methods of identifying equipment mounted to equipment racks/frames and the like are provided. According to some embodiments of the present invention, an equipment mounting system for rack-mounted devices, such as patch panels, servers, etc., includes a frame that is configured to support equipment mounted thereto in a plurality of spaced-apart mounting locations, and a plurality of RF antennas secured to the frame (e.g., via a printed circuit board) in spaced-apart relationship (e.g., vertical spaced-apart relationship, horizontal spaced-apart relationship, etc.) such that each antenna is located at a respective mounting location. Each RF antenna is configured to activate and read information from an RFID tag attached to equipment mounted to the frame at a respective mounting location. A microprocessor is configured to selectively activate each antenna to identify the presence of an RFID tag in close proximity to the RF antenna and to read information from an RFID tag.

The microprocessor is configured to receive RFID tag information (e.g., equipment identification information, location information, etc.) from each antenna and transmit received RFID tag information to a remote device.

According to some embodiments of the present invention, a method of identifying equipment mounted to a frame having a plurality of RF antennas secured thereto in spaced-apart relationship includes selectively activating each antenna to identify the presence of an RFID tag attached to equipment mounted to the frame at the respective antenna location and to read information from an RFID tag. According to other embodiments, a method of identifying available locations for equipment within a frame having a plurality of RF antennas secured thereto in spaced-apart relationship includes selectively activating each antenna on a frame to detect the presence of an RFID tag attached to equipment mounted to the frame at the respective antenna location.

### BRIEF DESCRIPTION OF THE DRAWINGS

FIG. 1 is a perspective view of a typical prior art communications rack assembly containing multiple patch panels with connector ports that are selectively interconnected by patch cords.

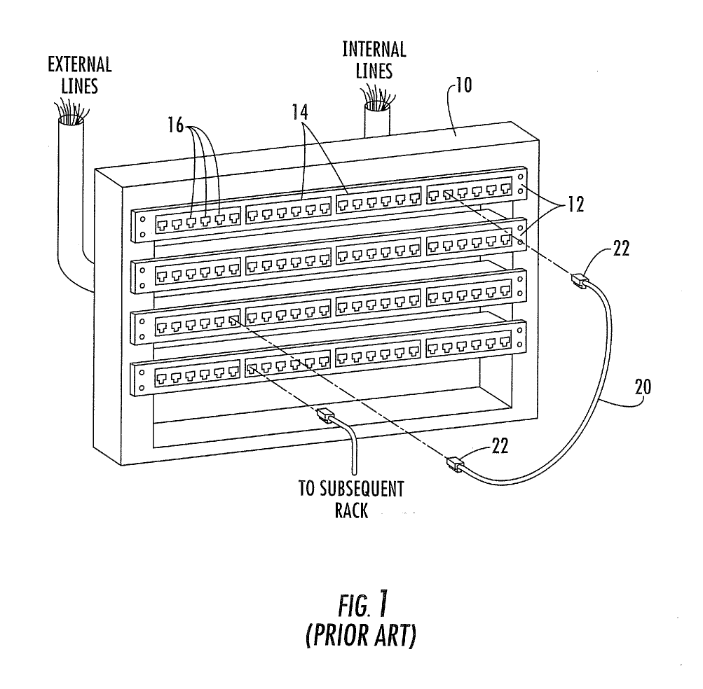

FIG. 2 illustrates an equipment mounting system, according to some embodiments of the present invention.

FIG. 3 is a flow chart of operations for identifying equipment mounted to a frame, according to some embodiments of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. As used herein, the term “and/or” includes any and all combinations of one or more of the associated listed items.

In the drawings, the thickness of lines, and elements may be exaggerated for clarity. It will be understood that when an element is referred to as being “on” another element, it can be directly on the other element or intervening elements may also be present. In contrast, when an element is referred to as being “directly on” another element, there are no intervening elements present. It will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present. The terms “upwardly”, “downwardly”, “vertical”, “horizontal” and the like are used herein for the purpose of explanation only.

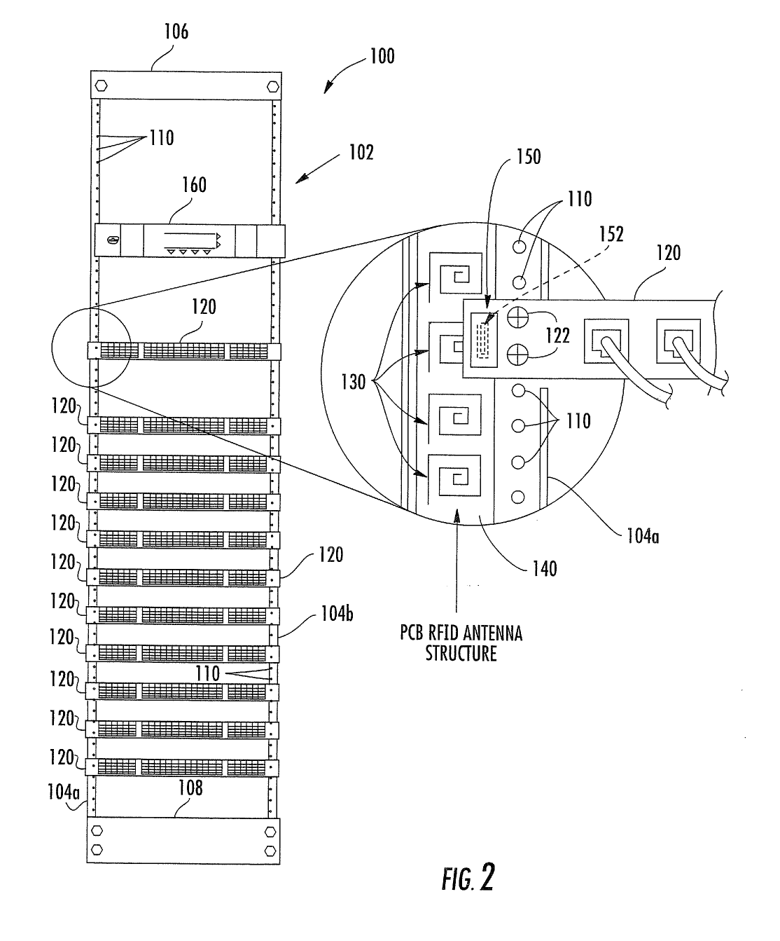

Referring now to FIG. 2, an equipment mounting system 100, according to some embodiments of the present invention, is illustrated. The illustrated mounting system 100 includes a frame 102 configured to support equipment mounted thereto in spaced-apart relationship. The frame 102 includes a pair of first and second vertically oriented members 104a, 104b in opposing spaced-apart relationship. The first and second members 104a, 104b are secured together and maintained in spaced-apart relationship via upper and lower cross members 106, 108, respectively. Embodiments of the present invention are not limited, however, to the illustrated frame configuration. Frames of any configuration, shape and size may be utilized in accordance with embodiments of the present invention. For example, frames that support equipment in horizontally spaced-apart relationship may also be utilized.

Each of the illustrated first and second members 104a, 104b includes a respective plurality of spaced-apart apertures 110 for securing equipment to the frame. Equipment, such as patch panels, servers, etc., are secured to the frame via bolts, screws, or other known fasteners, which are inserted through the apertures 100, as would be understood by those skilled in the art. In the illustrated embodiment, a plurality of communications patch panels 120 are mounted to the frame 102 via fasteners 122 in spaced-apart locations.

A plurality of RF (Radio Frequency) antennas 130 are secured to the frame first member 104a in spaced-apart relationship such that each antenna is positioned at a respective location where a patch panel can be secured to the frame 102. Each antenna 130 is configured to activate and read information from an RFID tag that is positioned adjacent thereto. The RF antennas 130 may be secured to the frame 102 in various ways (e.g., adhesively attached, attached via fasteners, etc.), as would be known to those skilled in the art. In the illustrated embodiment, the RF antennas 130 are attached to a printed circuit board (PCB) 140 which is secured to the frame first member 104a. The RF antennas 130 may be attached to a surface of the PCB 140, may be disposed within the PCB 140, or may have one or more portions disposed within the PCB 140 and one or more portions on a surface of the PCB 140, as would be understood by those skilled in the art.

A microprocessor (not illustrated) is disposed on or within the PCB 140 and is configured to selectively energize each antenna such that each antenna activates and reads information from an RFID (Radio Frequency IDentification) tag adjacent thereto. According to some embodiments, the microprocessor is connected to an RFID transceiver device (not shown), which is in turn connected to all of the antennas 130 on the frame 102 by way of a multiplexing device, which, under control of the microprocessor, connects the transceiver to one and only one antenna 130 at any given time. To activate any antenna 130 to read tag data from an RFID tag 150 located in proximity to that antenna 130, the following sequence would be executed by the microprocessor:
1) The microprocessor would configure the multiplexer to establish a connection between the RFID transceiver, and the specific RFID antenna 130 that is to be activated.
2) The microprocessor issues a command to activate the RFID transceiver device, which in turn energizes the selected antenna 130.
3) The RFID transceiver then monitors the antenna 130 to see if a signal from an RFID tag 150 is detected. If such a signal is detected, the RFID transceiver demodulates the RFID tag's signal and converts it into a digital bitstream, which is sent to the microprocessor.
4) The microprocessor monitors the digital data from the RFID transceiver until it has received all of the data from the RFID tag 150 in question.
5) The microprocessor sends a command to the RFID transceiver device to shut down, which de-energizes the selected antenna 130.

An RFID tag 150 is attached to each of the patch panels 120 at one end thereof. In the illustrated embodiment, an RFID tag 150 is attached at the left end portion of patch panel 120. RFID tags 150 are secured to patch panels 120 and other pieces of equipment to be mounted to the frame 102 such that the RFID tag 150 can be positioned in close proximity to a respective RF antenna 130 on the frame 102. An RFID tag 150 may be attached (e.g., adhesively attached, attached via fasteners, etc.) to the outer surface of a patch panel 120, server or other piece of equipment, as would be understood by those skilled in the art. Alternatively, an RFID tag 150 may be embedded within the material of a patch panel 120, server, etc., or may be located inside of a patch panel 120, server, etc., as long as the RFID tag 150 can be positioned in close proximity to and read by an RF antenna 130 on the frame 102. In addition, RFID tags 150 may be attached to patch panels 120, servers and other equipment in various orientations. It is desirable that the electromagnetic field lines of an RF antenna 130 penetrate as much of the area of an RFID tag 150 as possible. Accordingly, positioning an RFID tag 150 on equipment such that the RFID tag 150 can be close to an RF antenna 130 on a frame is desirable.

Embodiments of the present invention are not limited to the illustrated configuration of RF antennas 130 and RFID tags 150. For example, RF antennas 130 may be secured to the other frame member (second 10 member 104b) and the RFID tags 150 may be secured to the right end portion of a patch panel 120, servers, and other equipment to be mounted to the frame 102. In other embodiments, RF antennas 130 may be attached to both first and second members 104a, 104b.

Each RFID tag 150 includes an antenna 152 and a microchip (not shown) which stores various information (e.g., numbers, alphanumeric characters, etc.). For example, each RFID tag 150 may store information that identifies equipment to which the RFID tag is attached (e.g., a patch panel serial number, MAC address, model number and/or other equipment information etc.). In some embodiments, an RFID tag 150 may also include information that identifies a location of a piece of equipment. For example, an RFID tag 150 may include an identification of the location of a patch panel 120 in the frame 102 (e.g., first location from the top, third location from the top, etc.).

As would be understood by those skilled in the art of the present invention, each RFID tag 150 draws power from the RF field created by an RF antenna 130 when the RF antenna 130 is activated. The RFID tag 150 uses this power to power the circuits of its microchip to thereby transfer information stored therein.

In the illustrated embodiment, when an RF antenna 130 at the location of a patch panel 120 is energized by the microprocessor, the RFID tag antenna 152 is excited by the RF field generated by the RF antenna 130.

The RFID tag microchip then modulates waves containing information (e.g., equipment identification information, location information, etc.) stored within the RFID tag microchip and the RFID tag antenna 152 broadcasts these waves. The RF antenna 130 on the frame 102 detects the broadcast information and communicates this information to the microprocessor. The microprocessor converts the received waves into digital data and stores this data and/or transmits the data to a remote device. For example, the microprocessor may transmit data from RFID tags 150 to the rack controller 160 that controls various functions of the patch panels 120 secured to the frame 102. The microprocessor electrically connected with each of the RF antennas 130 may be virtually any type of processor, such as an 8-bit processor, and may retain a history of events within memory.

RFID tags 150 that resonate at any frequency may be utilized in accordance with embodiments of the present invention. RF antennas and their use in detecting RFID tags and interrogating RFID tags for information are well understood by those of skill in the art and need not be discussed further herein.

According to some embodiments of the present invention, RFID tags 150 can be factory installed on patch panels, servers and other equipment. Alternatively, RFID tags 150 can be retrofitted on patch panels, servers and other equipment in the field. When RFID tags 150 are factory installed, they can be programmed with information that indicates manufacturing date, operator's ID, factory code, serial numbers, MAC addresses, etc. If an RFID tag has read/write capabilities, then additional information could be added to the RFID tag in the field. For example, performance test data could be added to factory pre-programmed information.

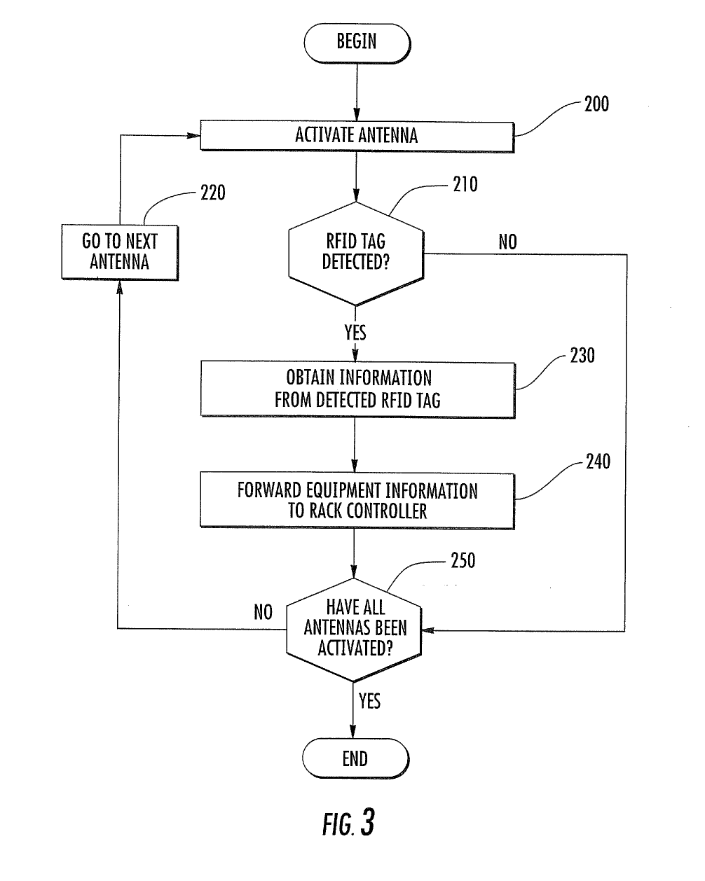

Referring now to FIG. 3, operations for identifying equipment mounted to a frame, according to embodiments of the present invention, are illustrated. Initially, an RF antenna 130 attached to the frame 102 is activated via a microprocessor (Block 200). If the activated antenna 102 detects an RFID tag 150 at the location of the antenna (Block 210), the antenna obtains information from the RFID tag 150 (e.g., equipment identification information, location information, etc.) (Block 230). The obtained information may then be forwarded to a remote device, such as a rack controller 160 (Block 240).

If no RFID tag 150 is detected (Block 210), a determination is made whether all antennas 130 have been activated (Block 250). If not, the microprocessor goes to the next RF antenna (Block 220) and activates that antenna (Block 200). The operations of Block 230 and Block 240 are performed if an RFID tag 150 is detected. If all of the antennas 130 have been activated (Block 250), operations are ended.

The operations of FIG. 3 are repeated so as to activate the RF antennas 130 on the frame 102. The RF antennas 130 may be sequentially activated or some other pattern of activation may be utilized. Operations represented by FIG. 3 may be performed at regular intervals and/or when requested.

According to some embodiments of the present invention, the rack controller 160 may send instructions to the PCB microprocessor to activate each RF antenna 130 to see if an RFID tag 150 is detected. If an RFID tag 150 is detected, the microprocessor sends the patch panel serial number and number of rack positions occupied by the patch panel 120 to the rack controller 160. The rack controller 160 can use this data to determine the order of the patch panels 120 within the frame 102 automatically, and can also forward this information to software used to manage/control the various patch panels 120.

Embodiments of the present invention may be utilized to identify equipment attached to any type of rack or frame. Embodiments of the present invention are not limited to racks or frames having vertically mounted equipment. Horizontally mounted equipment and other types of mounting configurations may also be utilized. For example, RF antennas 130 may be secured to a frame in horizontal spaced-apart relationship when patch panels (and other equipment) are mounted to the frame in horizontal spaced-apart relationship.

According to other embodiments of the present invention, RFID tags 150 can be affixed to various types of equipment in addition to patch panels, such as rack mounted servers. When mounted within a frame 102, other equipment, such as servers, can be detected and the exact location of the equipment can be automatically determined, as described above. This would be particularly useful in a data center environment, where there may be frequent need to add new servers, and in each such case need to determine which frames/cabinets in the data center have sufficient space available to accommodate the server in question.

According to other embodiments of the present invention, available locations within an equipment rack/frame can be identified via RF antennas 130 secured to the rack/frame at respective mounting locations. By selectively activating each antenna 130, the presence and absence of an RFID tag 150 can be detected. Not detecting the presence of an RFID tag at a rack/frame location can indicate that equipment is not mounted at that location. In addition, power and/or cooling information at a particular location can be determined via various environmental monitoring devices, as would be understood by those skilled in the art. Thus, a user seeking a available mounting locations within equipment mounting racks/frames with adequate power and cooling capacity can utilize embodiments of the present invention.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. An equipment mounting system, comprising:
a frame configured to support equipment mounted thereto in a plurality of spaced-apart mounting locations; and
a plurality of RF antennas secured to the frame in spaced-apart relationship such that each antenna is located at a respective mounting location, and wherein each antenna is configured to activate and read information from an RFID tag attached to equipment mounted to the frame at a respective mounting location.

2. The equipment mounting system of claim 1, wherein the frame comprises first and second vertically oriented members in opposing spaced-apart relationship, and wherein the antennas are secured to one of the first and second members in vertically spaced-apart locations.

3. The equipment mounting system of claim 1, wherein the frame comprises first and second horizontally oriented members in opposing spaced-apart relationship, and wherein the antennas are secured to one of the first and second members in horizontally spaced-apart locations.

4. The equipment mounting system of claim 1, further comprising a microprocessor configured to selectively energize each antenna such that each antenna activates and reads information from an RFID tag adjacent thereto.

5. The equipment mounting system of claim 4, wherein the microprocessor is configured to receive RFID tag information from each antenna and transmit received RFID tag information to a remote device.

6. The equipment mounting system of claim 4, wherein the microprocessor and plurality of antennas are attached to a printed circuit board, and wherein the printed circuit board is secured to the frame.

7. The equipment mounting system of claim 1, wherein the RFID tag information identifies equipment to which the RFID tag is attached.

8. The equipment mounting system of claim 1, wherein the RFID tag information comprises equipment identification information.

9. The equipment mounting system of claim 1, wherein the RFID tag information identifies a mounting location.

10. An equipment mounting system, comprising:
a frame;
a plurality of patch panels mounted to the frame in spaced-apart locations, wherein each patch panel has an RFID tag attached thereto; and
a plurality of RF antennas secured to the frame in spaced-apart relationship such that each antenna is positioned at a respective patch panel location, and wherein each antenna is configured to activate and read information from a patch panel RFID tag adjacent thereto.

11. The equipment mounting system of claim 10, wherein the frame comprises first and second vertically oriented members in opposing spaced-apart relationship, and wherein the antennas are secured to one of the first and second members in vertically spaced-apart locations.

12. The equipment mounting system of claim 10, wherein the frame comprises first and second horizontally oriented members in opposing spaced-apart relationship, and wherein the antennas are secured to one of the first and second members in horizontally spaced-apart locations.

13. The equipment mounting system of claim 10, further comprising a microprocessor configured to selectively energize each antenna such that each antenna can activate and read information from an RFID tag adjacent thereto.

14. The equipment mounting system of claim 13, wherein the microprocessor is configured to receive RFID tag information from each antenna and transmit received RFID tag information to a remote device.

15. The equipment mounting system of claim 14, wherein the remote device controls the plurality of patch panels.

16. The equipment mounting system of claim 13, wherein the microprocessor and plurality of antennas are attached to a printed circuit board, and wherein the printed circuit board is secured to the frame.

17. The equipment mounting system of claim 10, wherein each RFID tag is adhesively secured to a respective patch panel.

18. The equipment mounting system of claim 10, wherein the RFID tag information identifies equipment to which the RFID tag is attached.

19. The equipment mounting system of claim 10, wherein the RFID tag information identifies a mounting location.

20. A method of identifying equipment mounted to a frame, wherein a plurality of RF antennas are secured to the frame in spaced-apart relationship, the method comprising selectively activating each antenna to read information from an RFID tag attached to equipment mounted to the frame at the respective antenna location.

21. The method of claim 20, wherein the RFID tag information identifies equipment to which an RFID tag is attached.

22. The method of claim 20, wherein the RFID tag information identifies a location on the frame of equipment to which an RFID tag is attached.

23. A method of identifying available locations for equipment within a frame, wherein a plurality of RF antennas are secured to the frame in spaced-apart relationship, the method comprising selectively activating each antenna to detect the presence of an RFID tag attached to equipment mounted to the frame at the respective antenna location.

24. The method of claim 23, further comprising determining power and/or cooling specifications for selected frame locations.
